(19) United States
(12) Patent Application Publication
(10) Pub. No.: US 2014/0300474 A1
(43) Pub. Date: Oct. 9, 2014

(54) PUBLIC INFORMATION NOTIFICATION SYSTEM

(71) Applicant: CASA JEFFERSON, Gretna, LA (US)

(72) Inventor: Dennis Lomonaco, Gretna, LA (US)

(73) Assignee: CASA Jefferson, Gretna, LA (US)

(21) Appl. No.: 13/857,120

(22) Filed: Apr. 4, 2013

(51) Int. Cl. G08B 5/36

(52) U.S. Cl. CPC G08B 5/36
USPC 340/573.1

(57) ABSTRACT

The present invention relates to the use of illumination to inform the public about the occurrence of an event involving an individual, and especially the abuse or neglect of a child. The invention also teaches the use of illumination in conjunction with additional means of informing the public, thereby heightening public awareness, and improving public support for a particular cause.

### FIELD OF THE INVENTION

The present invention generally relates to systems and methods for informing the public about the occurrence of significant events, particularly those relating to child abuse, neglect, and death associated therewith.

### SUMMARY OF THE INVENTION

In various embodiments, the invention teaches a system for informing one or more members of the public about an occurrence of an event involving an individual. In certain embodiments, the system includes: a light source; a light source controller; and a computer system, wherein the computer system is configured to (1) interface with one or more sources of electronic information, (2) determine the presence or absence of information indicating the occurrence of the event, contained within the one or more sources of electronic information, and (3) send a signal to the light source controller that causes the light source controller to turn the light source on or off, if the event is determined. In some embodiments, the light source is selected from the group consisting of an electric torch, a gas torch, a spotlight, and an electric sign. In some embodiments, one or more of the sources of electronic information are selected from the group consisting of: an electronic newsfeed, an electronic newsletter, a data aggregation website, an electronic journal, a social networking website, a law enforcement agency database, a law enforcement agency website, a court system database, a court system website, a foster care facility database, and a database of another computer. In certain embodiments, the event is selected from the group consisting of: abuse of an individual, neglect of an individual, and death of an individual, or the anniversary thereof. In various embodiments, the individual is a child. In some embodiments, the light source provides light of a type selected from the group consisting of: white light, colored light, and fluorescent light. In some embodiments, the light source is configured to illuminate a publicly viewable area. In various embodiments, the publicly viewable area is selected from the group consisting of: one or more sections of sky, one or more sections of a wall, one or more sections of an exterior of a building, one or more sections of an interior of a building, one or more sections of vegetation, one or more sections of a body of water, one or more sections of a means for transportation, one or more sections of a billboard, and combinations thereof. In various embodiments, the light source is turned on or off until a public and/or private action is taken, and wherein the public and/or private action is selected from the group consisting of: a donation of a threshold amount of public and/or private funds to a specific organization, a beginning or an ending of a court proceeding, a conviction of an individual implicated in a crime against a child, a memorial service, a commitment by an individual to serve as a court appointed special advocate, and combinations thereof.

In various embodiments, the invention teaches a method for informing one or more members of the public about an occurrence of an event involving an individual, including: providing a system for informing one or more members of the public about an occurrence of an event involving an individual, including: a light source; a light source controller; and a computer system, wherein the computer system is configured to (1) interface with one or more sources of electronic information, (2) determine the presence or absence of information indicating the occurrence of the event, contained within the one or more sources of electronic information, and (3) send a signal to the light source controller that causes the light source controller to turn the light source on or off, if the event is determined; and using the system to illuminate or interrupt the illumination of a publicly viewable area. In some embodiments, the light source of the system is selected from the group consisting of an electric torch, a gas torch, a spotlight, and an electric sign. In some embodiments, one or more of the sources of electronic information with which the computer system interfaces is selected from the group consisting of: an electronic newsfeed, an electronic newsletter, a data aggregation website, an electronic journal, a social networking website, a law enforcement agency database, a law enforcement agency website, a court system database, a court system website, a foster care facility database, and a database of another computer. In some embodiments, the event is selected from the group consisting of: abuse of an individual, neglect of an individual, and death of an individual, or the anniversary thereof. In certain embodiments, the individual is a child. In some embodiments, the light source provides light of a type selected from the group consisting of: white light, colored light, and fluorescent light. In various embodiments, the publicly viewable area is selected from the group consisting of: one or more sections of sky, one or more sections of a wall, one or more sections of an exterior of a building, one or more sections of an interior of a building, one or more sections of vegetation, one or more sections of a body of water, one or more sections of a means for transportation, one or more sections of a billboard, and combinations thereof. In various embodiments, the light source is turned on or off until a public and/or private action is taken, and wherein the public and/or private action is selected from the group consisting of: a donation of a threshold amount of public and/or private funds to a specific organization, a beginning or an ending of a court proceeding, a conviction of an individual implicated in a crime against a child, a memorial service, a commitment by an individual to serve as a court appointed special advocate for a child, and combinations thereof. In some embodiments, the method further includes providing information to the public about the nature of the event. In some embodiments, the information is provided to the public through the use of one or more resources selected from the group consisting of: a website, an email, a text message, a social networking service, a newspaper, a magazine, and combinations thereof.

### BACKGROUND

The following description includes information that may be useful in understanding the present invention. It is not an admission that any of the information provided herein is prior art, or relevant to the presently claimed invention.

There are many options available for informing the public about important matters, including the use of hand held signs, billboards, newspapers, television, e-mail, websites, and social networking platforms. The relative ease with which these various modes of communication can be used has resulted in a steadily increasing and often overwhelming daily exposure to messaging for the average person. Not surprisingly, as the amount of “message exposure” increases, so do an individual's information avoiding behaviors (Consumer perceptions of advertising clutter and its impact across various media. Journal of Advertising Research, 38(1), 29-41). As a result, important information about matters of public concern is often blocked by the technological and mental filters employed by a populous that is ever more inundated with messaging. Although many strategies and technologies have been developed to overcome this issue, there is clearly a need in the art for improved methods for public communication.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 depicts, in accordance with an embodiment of the invention, a diagram of hardware and an operating environment in conjunction with which implementations of the inventive lighting system's web server and other computing devices described herein may be practiced.

FIG. 2 depicts, in accordance with an embodiment of the invention, a diagram of an automated lighting system.

FIG. 3A depicts, in accordance with an embodiment of the invention, a diagram including multiple views of a light that can be used in conjunction with the inventive lighting system (dimensions are represented in inches) and method. FIG. 3B depicts, in accordance with an embodiment of the invention, a diagram of a light that can be used in conjunction with the inventive lighting system and method.

### DETAILED DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Indeed, the present invention is in no way limited to the methods and materials described.

Communicating with the public is an important part of advocating for abused and neglected children. Increased public awareness can lead to greater support and funding for programs ranging from those focused on helping to train teachers, caregivers, coaches, and others to identify instances of abuse and neglect at an early stage, to those focused on recruiting a greater number of advocates for children who have been abused or neglected, such as court appointed special advocate (CASA) volunteers.

By way of background, CASA volunteers are more and more frequently appointed by judges to watch over and advocate for abused and neglected children, to make sure they don't get lost in the overburdened legal and social service system or languish in inappropriate group or foster homes. Each year, more than 600,000 children experience foster care in the United States. As there are not enough CASA volunteers to represent all of the children in care, judges typically assign CASA volunteers to only their most difficult cases. Motivated, in part, by the shortfall of support, volunteers, and resources in general, the inventors developed new systems and methods for increasing public awareness about abused and neglected children.

In some embodiments, the invention teaches a system for informing one or more members of the public about the occurrence of an event involving an individual. In some embodiments, the system includes a light source; a light source controller; and a computer system. In various embodiments, the computer system is configured to (1) interface with one or more sources of electronic information, (2) determine the presence or absence of information, contained within the one or more sources of electronic information, indicating the occurrence of an event, and (3) send a signal to the light source controller that causes it to turn the light source on or off, depending upon the nature of the information received from the one or more sources of information.

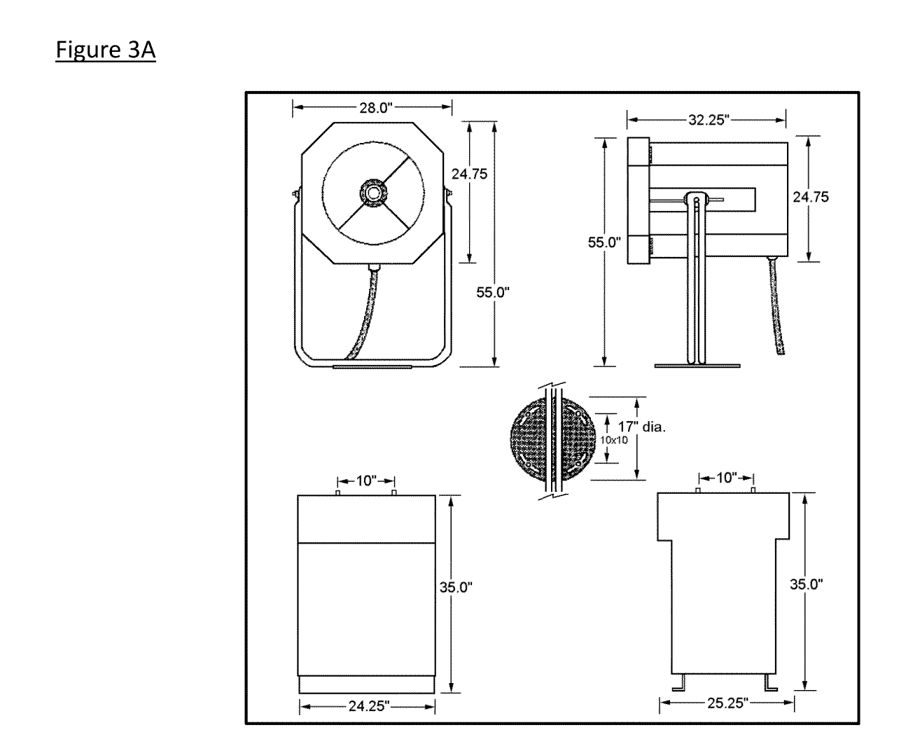

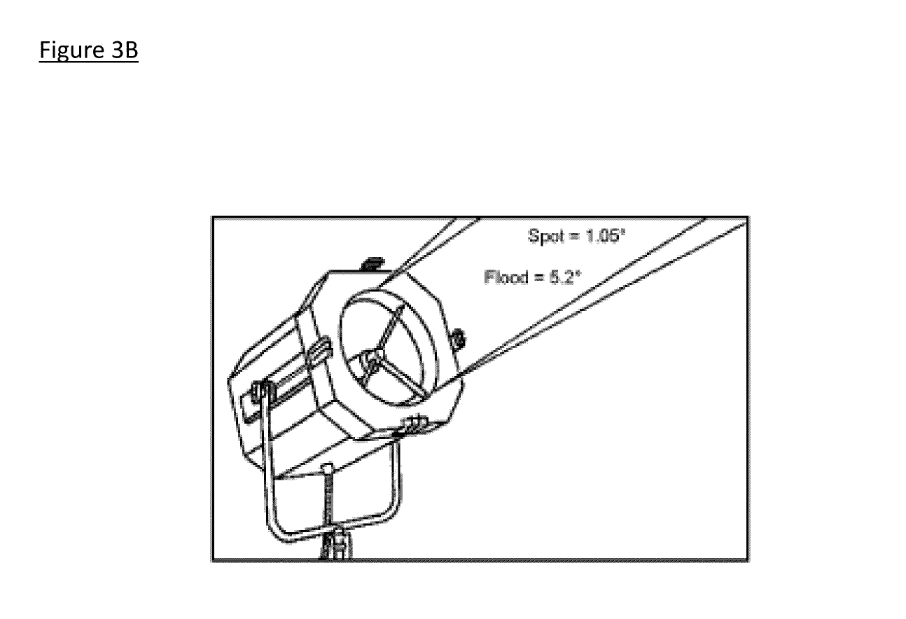

One of skill in the art would readily appreciate that any of a number of light sources can be used in conjunction with the inventive system. Merely by way of non-limiting examples, the light source can be an electric torch, a gas torch, a spotlight, an electric sign, or the like. In an embodiment, the light source is a spotlight configured to be mounted on a building, or on the ground near a building. In certain embodiments, the light source is of a type depicted in FIGS. 3A and 3B. In some embodiments, the light source is designed to have a throw distance of 50 to 1000 feet, or more. In some embodiments, the light source has a beam diameter of 10 to 500 inches, or more. In some embodiments, the diameter of the front aperture of the light is from 5 to 50 inches, or more. In some embodiments, the light is configured to function as a spotlight. In alternative embodiments, the light is configured to function as a floodlight. In some embodiments, the peak candlepower of the light is from 500 million to 1 billion, or more. In some embodiments, the light uses a forced air cooling system. However, one of skill in the art would readily appreciate that many different cooling systems could be used in conjunction with a light of the type shown in FIG. 3A and 3B. In some embodiments, the light is a Strong Britelight® 7000, manufactured by Xenotech®. In certain embodiments, two or more of any of the lighting sources described herein can be used in conjunction with the inventive methods.

The sources of electronic information that can be used in conjunction with the inventive system can include, but are in no way limited to an electronic newsfeed, an electronic newsletter, a data aggregation website, an electronic journal, a social networking website, a law enforcement agency database, a law enforcement agency website, a court system database, a court system website, a foster home database, and a database of another computer. In some embodiments, one or more of the aforementioned information sources are automatically populated with information based upon pre-determined algorithms and data mining routines. In other embodiments, one or more of the aforementioned information sources are manually populated with information concerning relevant events by entering information discovered through searching one or more sources of pertinent information.

One of skill in the art would readily appreciate that the event signified by lighting the public area (or withdrawing light from a public area), and determined from reviewing the aforementioned electronic resources, can be any of a number of events. Merely by way of non-limiting examples, the event can include an instance or episode of abuse or neglect of an individual, death of an individual, or an anniversary thereof. In certain embodiments of the invention, the individual is a child.

With respect to the nature of the light emitted by the light source, any of a number of types of light can be used. For example, the light source can emit light of a type including, but in no way limited to, white light, colored light, or fluorescent light. The light can also be any of a variety of constant or varying intensities, ranging from very dim to very bright or flashing light. Furthermore, specific colors or combinations of colors of light can be used to indicate particular kinds of events. Merely by way of non-limiting examples, a red light can be used to indicate an instance of child abuse, a green light can be used to indicate a child's death, and a white light can be used to indicate a successful placement of an abused, neglected or orphaned child into a temporary or permanent home, or the assignment of a CASA to a child.

In certain embodiments, the system is configured such that the light source illuminates a publicly viewable area when it is turned on. The publicly viewable area can include many different types of spaces. Merely by way of non-limiting examples, the publicly viewable area can include one or more sections of sky, a wall, the exterior of a building, the interior of a building, a body of water, a means for transportation, a billboard, and combinations thereof. In some embodiments, the light can originate from a spotlight housed on a structure associated with child advocacy. Merely by way of non-limiting examples, the structure can be a statue, a grave, or a monument. The structure can also be an office building associated with child advocacy, such as the headquarters or a branch of a child advocacy organization. In some embodiments, a spotlight is attached to a building and an intense light is shined into the sky so that it can be seen from up to one hundred feet away. In some embodiments, the light is intense enough that it can be seen from up to one hundred yards away. In some embodiments, the light is intense enough that it can be seem from up to one thousand yards away. In some embodiments, the light is intense enough that it can be seen from up to several miles away.

One of skill in the art would readily appreciate that the systems described herein can be configured to allow for illumination of a publicly viewable area for any desirable length of time. In certain embodiments, the system can be configured such that illumination of the publicly viewable area automatically persists until a specific public and/or private action is taken. In some embodiments, the public and/or private action can include, but is in no way limited to, a donation of a threshold amount of public and/or private funds to a specific cause, a beginning or an ending of a court proceeding, a conviction of an individual implicated in a crime against a child, a memorial service, a commitment by a CASA to advocate for a child that has been abused or neglected, or combinations thereof.

In some embodiments, the system is configured to provide information to the public concerning the nature of any of the aforementioned events detected. In some embodiments, the information is made available to the public by one or more method, including but in no way limited to posting information about the event on a website, sending an email, sending a text message, using a social networking service, and combinations thereof. In some embodiments, the information is made available to the public contemporaneously with the illumination of the publicly viewable area. In some embodiments, the information is made available to the public prior to the illumination of the publicly viewable area. In some embodiments, the information is made available to the public after the illumination of the publicly available area. In an embodiment, the system is configured such that information concerning an event of interest is automatically gathered from one or more of the aforementioned electronic sources, subsequently formatted in a pre-determined way, and then posted on a website for public viewing. In some embodiments, the event involves a child and only certain aspects of the event are included in the information made available to the public, while other aspects, including but not limited to the identity of the child, are concealed to protect his or her privacy.

In some embodiments of the invention, rather than indicating the occurrence of an event involving an individual by illuminating a publicly viewable area, the system is configured to interrupt illumination of an otherwise constantly (or nearly constantly) illuminated area in order to signify the occurrence of the event. For example, a spotlight can be used to illuminate a region of the sky for all or part of the night on a regular basis, until a particular event occurs. When that event occurs, and is detected by the system described herein, the light source is automatically turned off by the light source controller (or manually) for a pre-determined period of time. The interruption of illumination can persist for any of a range of periods of time. In some embodiments, the illumination can be interrupted until the occurrence of any of the events indicated above, such as the appointment of a CASA for a child in need thereof In some embodiments, the illumination is interrupted for a fixed period of time correlated with a specific event. For example, the illumination can be interrupted for one day (or longer) to signify the abuse, neglect, death, or an anniversary of the death of a child.

In various embodiments, the invention teaches a method for informing one or more members of the public about the occurrence of an event involving an individual. In some embodiments, the method includes using any of the aforementioned systems to illuminate or interrupt the illumination of a publicly viewable area.

One of skill in the art would readily appreciate there are many configurations of computer systems capable of automatically (1) interfacing with one or more electronic sources to determine the presence or absence of information indicating the occurrence of a specific event, (2) processing the information received from one or more sources concerning the presence or absence of a specific event, and (3) turning a light source on or off, depending upon the nature of the information received.

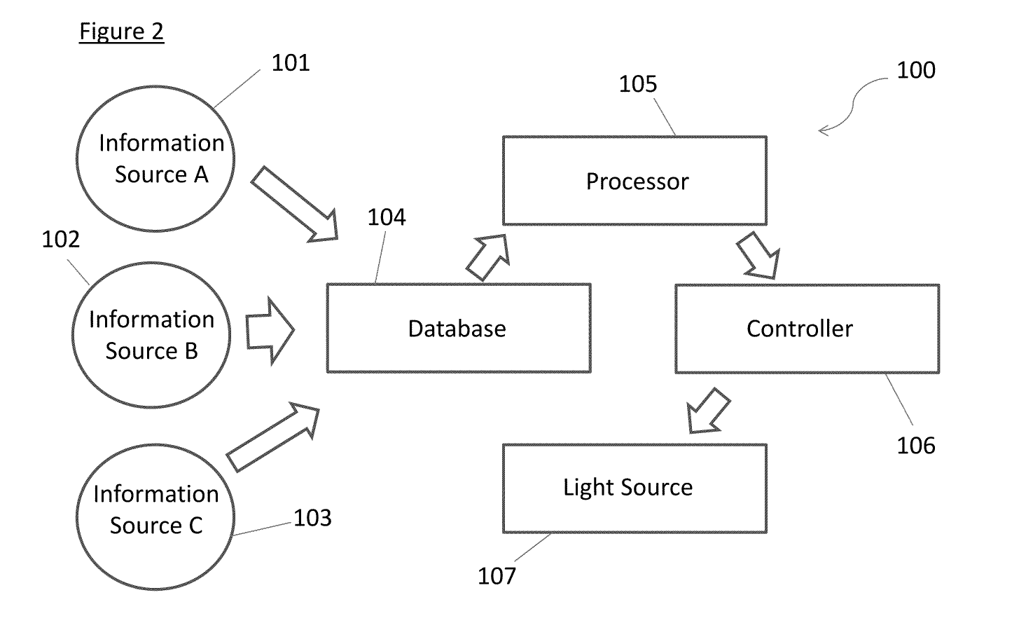

As depicted in FIG. 2, in some embodiments the automated illumination system 100 is used to interface with one or more information sources 101-103 and determine the presence or absence of information indicating the occurrence of a specific event. After the database 104 receives and stores information from the sources of information 101-103 concerning the presence or absence of one or more events, the processor 105 determines whether or not the light source 107 should be turned on or off. If the processor determines that the light source should be turned on or off, then a signal is communicated to the controller 106, which acts upon the light source 107 to turn it on or off, as appropriate, thereby illuminating or interrupting the illumination of a publicly viewable area.

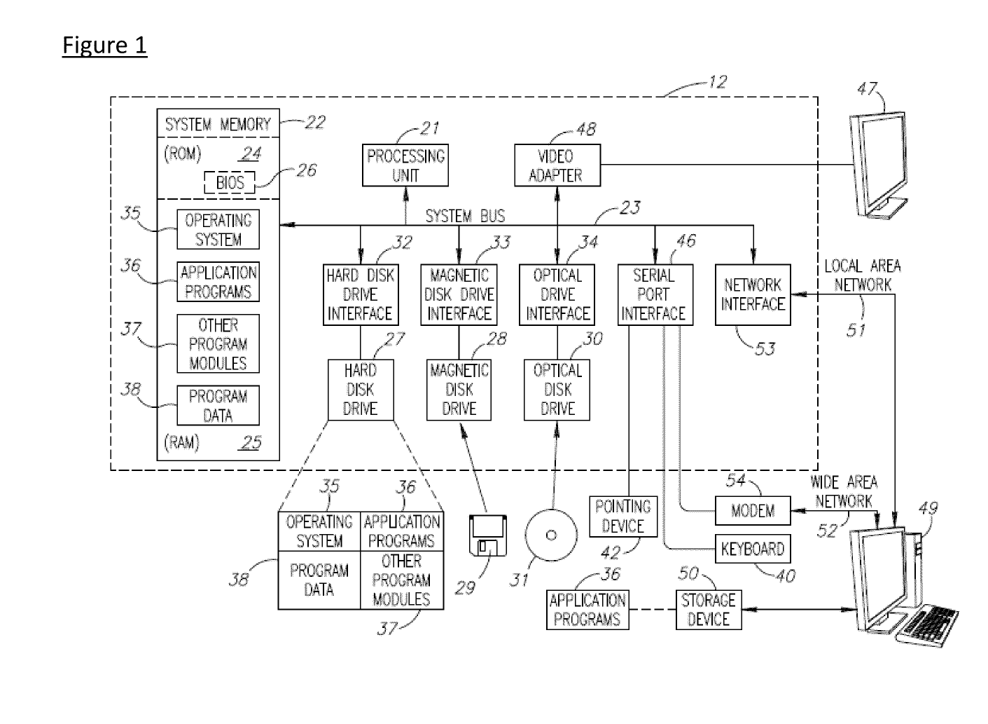

FIG. 1 is a diagram of hardware and an operating environment in conjunction with which implementations of the automated lighting system's computing devices discussed herein may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general-purpose computing device in the form of a computing device 12. Any of the aforementioned computing devices may each be implemented using one or more computing devices like the computing device 12.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like. The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard 5 disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial 5 bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types physical feedback (e.g., a force feedback game controller).

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device.

The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 10 include a local-area network (LAN) 51 and a wide-area network (WAN) 52. Such networking environments are commonplace in offices, enterprise-wide computer networks, intranets and the Internet.

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN networking environment, the computing device 12 typically includes a modem 54, a type of communications device, or any other type of communications device for establishing communications over the wide area network 52, such as the Internet.

The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

### EXAMPLES

### Example 1

### Illumination of a Publicly Viewable Area

A system for illuminating a publicly viewable area can be used to improve public awareness regarding instances or episodes of child abuse, neglect, and death that results therefrom. The system includes a spotlight anchored to a building known to be associated with an organization focused on child advocacy. The system further includes a computer system connected to a light source controller, which is in turn connected to the spotlight. A volunteer or employee of the child advocacy organization searches for information indicating that abuse, neglect, death of a child, or anniversary of the death of a child has occurred. The volunteer uses a computer to store information about the particulars of the event in a database. The computer system of the present invention is configured to periodically interact with the database to determine if any new information about any of the aforementioned circumstances has been stored. If new information has been stored, then the computer system sends a signal to the light source controller to turn the spotlight off. The spotlight, which is aimed at the sky and normally turned on at night, is turned off for a predetermined length of time associated with the particular event detected, thereby signifying the occurrence of that event to the public. If the event detected by the system is child abuse, and the system has been configured to interrupt illumination of the sky for two days in the event that an instance of child abuse is detected, then the spotlight will remain off for two days, and then will be turned back on automatically. The system would interrupt illumination in the same manner (for predetermined periods of time) for other events, such as the anniversary of a child's death due to neglect or abuse.

As an alternative to the above configuration, the system can also be configured such that the spotlight is generally off each night, but turned on in the event that an instance of child abuse, neglect, or death attributed thereto is detected by the system.

### Example 2

### Association of Illumination and Instances of Abuse, Neglect and Death

The present invention allows for the association of an instance of child abuse, neglect or related death with the illumination or interruption of illumination of a publicly viewable area. After an instance of child abuse or neglect is detected by the system, information concerning the abuse or neglect is automatically organized according to a predetermined format and posted to a publicly available website. The information posted on the website indicates that a child of a certain age within a particular community has been abused, neglected, or killed. The information posted on the website does not include private details about the victim to the extent such information is prohibited by law or deemed inappropriate in the discretion of the individual managing the system. In addition to indicating that an instance of abuse, neglect, or death of a child has occurred, the website is also automatically updated to indicate that the aforementioned spotlight will shine (or will be interrupted from shining, depending upon how the system is configured) for a specific amount of time, in order to signify the occurrence of the abuse, neglect, or death, as appropriate. By using the inventive system, the public will become increasingly more aware of the instances of child abuse, neglect, and death, as information about the spotlight and its significance spreads throughout the community.

One skilled in the art will recognize many methods and materials similar or equivalent to those described herein, which could be used in the practice of the present invention. Indeed, the present invention is in no way limited to the methods and materials described.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A system for informing one or more members of the public about an occurrence of an event involving an individual, comprising:
a light source;
a light source controller; and
a computer system, wherein the computer system is configured to (1) interface with one or more sources of electronic information, (2) determine the presence or absence of information indicating the occurrence of the event, contained within the one or more sources of electronic information, and (3) send a signal to the light source controller that causes the light source controller to turn the light source on or off, if the event is determined.

2. The system of claim 1, wherein the light source is selected from the group consisting of an electric torch, a gas torch, a spotlight, and an electric sign.

3. The system of claim 1, wherein one or more of the sources of electronic information are selected from the group consisting of: an electronic newsfeed, an electronic newsletter, a data aggregation website, an electronic journal, a social networking website, law enforcement agency database, a law enforcement agency website, a court system database, a court system website, a foster care facility database, and a database of another computer.

4. The system of claim 1, wherein the event is selected from the group consisting of: abuse of an individual, neglect of an individual, death of an individual, and the anniversary of the death of an individual.

5. The system of claim 4, wherein the individual is a child.

6. The system of claim 1, wherein the light source provides light of a type selected from the group consisting of: white light, colored light, and fluorescent light.

7. The system of claim 1, wherein the light source is configured to illuminate a publicly viewable area.

8. The system of claim 7, wherein the publicly viewable area is selected from the group consisting of: one or more sections of sky, one or more sections of a wall, one or more sections of an exterior of a building, one or more sections of an interior of a building, one or more sections of vegetation, one or more sections of a body of water, one or more sections of a means for transportation, one or more sections of a billboard, and combinations thereof.

9. The system of claim 1, wherein the light source is turned on or off until a public and/or private action is taken, and wherein the public and/or private action is selected from the group consisting of: a donation of a threshold amount of public and/or private funds to a specific organization, a beginning or an ending of a court proceeding, a conviction of an individual implicated in a crime against a child, a memorial service, a commitment by an individual to serve as a court appointed special advocate, and combinations thereof

10. A method for informing one or more members of the public about an occurrence of an event involving an individual, comprising:
providing a system for informing one or more members of the public about an occurrence of an event involving an individual, comprising:
a light source;
a light source controller; and
a computer system, wherein the computer system is configured to (1) interface with one or more sources of electronic information, (2) determine the presence or absence of information indicating the occurrence of the event, contained within the one or more sources of electronic information, and (3) send a signal to the light source controller that causes the light source controller to turn the light source on or off, if the event is determined; and
using the system to illuminate or interrupt the illumination of a publicly viewable area.

11. The method of claim 10, wherein the light source of the system is selected from the group consisting of an electric torch, a gas torch, a spotlight, and an electric sign.

12. The method of claim 10, wherein one or more of the sources of electronic information with which the computer system interfaces is selected from the group consisting of: an electronic newsfeed, an electronic newsletter, a data aggregation website, an electronic journal, a social networking website, law enforcement agency database, a law enforcement agency website, a court system database, a court system website, a foster care facility database, and a database of another computer.

13. The method of claim 10, wherein the event is selected from the group consisting of: abuse of an individual, neglect of an individual, death of an individual, and the anniversary of the death of an individual.

14. The method of claim 13, wherein the individual is a child.

15. The method of claim 10, wherein the light source provides light of a type selected from the group consisting of: white light, colored light, and fluorescent light.

16. The method of claim 10, wherein the publicly viewable area is selected from the group consisting of: one or more sections of sky, one or more sections of a wall, one or more sections of an exterior of a building, one or more sections of an interior of a building, one or more sections of vegetation, one or more sections of a body of water, one or more sections of a means for transportation, one or more sections of a billboard, and combinations thereof.

17. The method of claim 10, wherein the light source is turned on or off until a public and/or private action is taken, and wherein the public and/or private action is selected from the group consisting of: a donation of a threshold amount of public and/or private funds to a specific organization, a beginning or an ending of a court proceeding, a conviction of an individual implicated in a crime against a child, a memorial service, a commitment by an individual to serve as a court appointed special advocate for a child, and combinations thereof.

18. The method of claim 10, further comprising providing information to the public about the nature of the event.

19. The method of claim 18, wherein the information is provided to the public through the use of one or more resources selected from the group consisting of: a website, an email, a text message, a social networking service, a newspaper, a magazine, and combinations thereof.
